(19) United States
(12) Patent Application Publication
(10) Pub. No.: US 2019/0099796 A1
(43) Pub. Date: Apr. 4, 2019

(54) MANUFACTURING METHOD OF BASE MEMBER OF ROTATABLE FIXING MEMBER AND MANUFACTURING METHOD OF THE ROTATABLE FIXING MEMBER

(71) Applicant: CANON KABUSHIKI KAISHA, Tokyo (JP)

(72) Inventors: Naoki Akiyama, Moriya-shi (JP); Satoshi Ohtake, Toride-shi (JP)

(21) Appl. No.: 16/137,775

(22) Filed: Sep. 21, 2018

(30) Foreign Application Priority Data
Oct. 3, 2017 (JP) 2017-193375

(51) Int. Cl. B21D 22/28; G03G 15/20; B21D 24/16; B21D 51/10

(52) U.S. Cl. CPC B21D 22/28; B21D 51/10; B21D 24/16; G03G 15/2057

(57) ABSTRACT

A manufacturing method of a stainless-steel-made base member includes a first step of forming, from a stainless-steel-made first cup-shaped member held at an inside portion thereof by a holding member, a second cup-shaped member made thinner than the first cup-shaped member by ironing an outside portion of the first cup-shaped member with a ring-shaped member movable in a longitudinal direction of the holding member; a second step of extracting the second cup-shaped member out of the holding member; and a third step of cutting a bottom end portion of the second cup-shaped member with respect to the longitudinal direction. The first cup-shaped member has Vickers hardness of not less than 200 HV0.3/10 or more and not more than 280 HV0.3/10, and the holding member has Vickers hardness which is not less than four times and not more than nine times the Vickers hardness of the first cup-shaped member.

### FIELD OF THE INVENTION

The present invention relates to a manufacturing method of a base member of a rotatable fixing member and a manufacturing method of the rotatable fixing member.

In an electrophotographic image forming apparatus, conventionally, a fixing device for heat-fixing an unfixed toner image on a recording material is mounted.

In fixing devices disclosed in Japanese Laid-Open Patent Application (JP-A) 2003-156954 and JP-A 2002-346647, as a base member of a fixing belt, use of stainless steel excellent in heat conductivity has been proposed.

As regards such a fixing belt, in recent years, with speed-up of a printing method, a lifetime extension has been strongly desired. For the lifetime extension of the fixing belt, it is desirable that bending durability of a base member performing a function of maintaining strength of the fixing belt is improved.

### SUMMARY OF THE INVENTION

A principal object of the present invention is to provide a manufacturing method of a base member of a rotatable fixing member excellent in bending durability and a manufacturing method of the rotatable fixing member.

According to an aspect of the present invention, there is provided a manufacturing method of a stainless-steel-made base member of a rotatable fixing member, the manufacturing method comprising: a first step of forming, from a first cup-shaped member made of a stainless steel and held at an inside portion thereof by a holding member, a second cup-shaped member made thinner than the first cup-shaped member by ironing an outside portion of the first cup-shaped member with a ring-shaped member movable in a longitudinal direction of the holding member; a second step of extracting the second cup-shaped member out of the holding member; and a third step of cutting a bottom end portion of the second cup-shaped member with respect to the longitudinal direction, wherein the first cup-shaped member has Vickers hardness of not less than 200 HV0.3/10 or more and not more than 280 HV0.3/10, and the holding member has Vickers hardness which is not less than four times and not more than nine times the Vickers hardness of the first cup-shaped member.

According to another aspect of the present invention, there is provided a manufacturing method of a rotatable fixing member comprising: (i) a manufacturing step of manufacturing a base member made of stainless steel; (ii) a forming step of forming a surface layer outside the base member manufactured by the manufacturing step, wherein the manufacturing step comprises, (ii-i) a first step of forming, from a first cup-shaped member made of a stainless steel and held at an inside portion thereof by a holding member, a second cup-shaped member made thinner than the first cup-shaped member by ironing an outside portion of the first cup-shaped member with a ring-shaped member movable in a longitudinal direction of the holding member, (ii-ii) a second step of extracting the second cup-shaped member out of the holding member, and (ii-iii) a third step of cutting a bottom end portion of the second cup-shaped member with respect to the longitudinal direction, wherein the first cup-shaped member has Vickers hardness of not less than 200 HV0.3/10 or more and not more than 280 HV0.3/10, and the holding member has Vickers hardness which is not less than four times and not more than nine times the Vickers hardness of the first cup-shaped member.

Further features of the present invention will become apparent from the following description of exemplary embodiments with reference to the attached drawings.

### BRIEF DESCRIPTION OF THE DRAWINGS

FIG. 1 is a schematic structural view of an image forming apparatus.

FIG. 2 is a schematic structural view of a fixing device.

FIG. 3 is a schematic view showing a cross-section of a fixing belt.

FIG. 4 is a schematic view showing a coating device used in a ring coating method.

FIG. 5 is a schematic view showing fixing belt forming steps.

Parts (a) to (c) of FIG. 6 are schematic views showing a step of manufacturing a metal pipe in a first stage by deep drawing.

Parts (a) to (d) of FIG. 7 are schematic views showing a step of manufacturing a fixing belt base member (SUS base member) from a metal pipe in a third stage.

Parts (a) to (d) of FIG. 8 are schematic views showing a process in which the metal pipe in the third stage generates scars on a processing punch surface.

### DESCRIPTION OF EMBODIMENTS

In the following, embodiments of the present invention will be described with reference to the drawings. Incidentally, various constituent elements described in the following embodiments may also be replaced with other known constituent elements within the scope of a concept of the present invention unless otherwise specified.

### First Embodiment

### [Image Forming Apparatus]

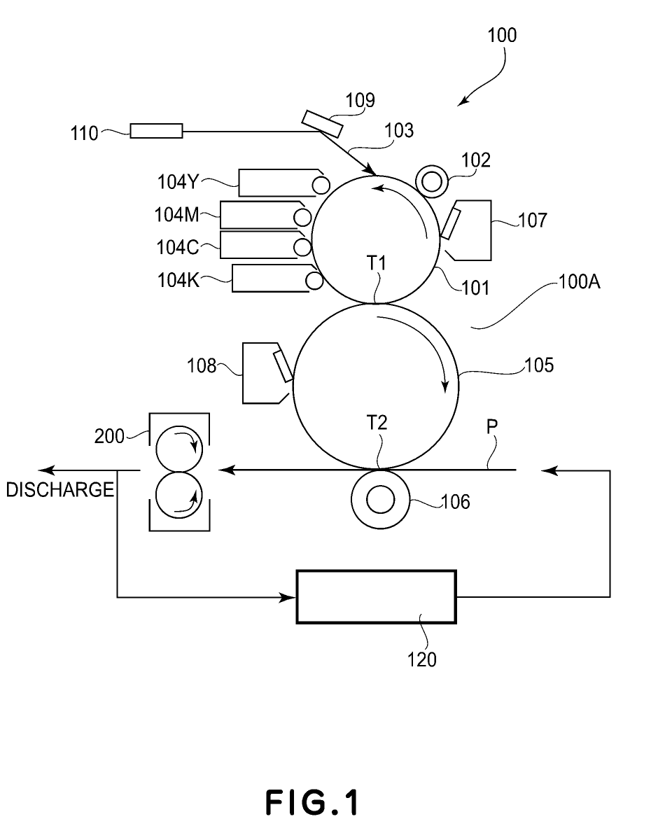

FIG. 1 is a schematic view of an example of an image forming apparatus. An image forming apparatus 100 in this embodiment is a four-color-based full-color laser printer (color image forming apparatus) using an electrophotographic process.

In an image forming portion 100A, a toner image is formed through an electrophotographic process including a charging step, an exposure step, a developing step and the like. That is, around a photosensitive drum 101 as a photosensitive member, constituent members for carrying out the electrophotographic process are provided. Specifically, a charging roller 102 as a charging device, an exposure device which includes a laser light source 110 and a mirror 109 and which emits laser light 103 toward the drum 101 are disposed in a named order around the drum 101. Further, developing devices 104Y, 104M, 104C and 104K, an intermediary transfer member 105 as a transfer portion, and a cleaner 107 are disposed in a named order around the drum 101.

During execution of an image forming process, the drum 101 is rotated in an arrow direction of FIG. 1 at a predetermined process speed (peripheral speed). In the image forming process, the following processes are successively performed along a rotational direction of the drum 101. First, the drum 101 is electrically charged at a surface thereof to a predetermined polarity by the charging roller 102.

Then, the charged drum 101 is subjected to an exposure process by the laser light 103 outputted from the exposure device. The exposure device acquires image information from an unshown external terminal such as an image reading device or a personal computer. The exposure device outputs the laser light 103 modulated (ON/OFF) correspondingly to a pixel signal corresponding to the image information for an associated color. Then, the surface of the photosensitive drum 101 is subjected to scanning exposure. The laser light 103 is deflected by the mirror 109 to an exposure position of the drum 101. Thus, on the surface of the drum 101, the scanning exposure is carried out, so that an electrostatic latent image corresponding to the image information is formed on the surface of the drum 101.

Then, the electrostatic latent image formed on the drum 101 is visualized as a yellow toner image with a yellow toner by the developing device 104Y. This yellow toner image is transferred onto a surface of an intermediary transfer member 105 at a primary transfer portion T1 which is a contact portion between the drum 101 and the intermediary transfer member 105. Incidentally, the toner remaining on the surface of the drum 101 is removed by the cleaner 107. A process cycle of charging, exposure, development, primary transfer and a cleaning as described above is similarly repeated also during formation of each of a magenta toner image, a cyan toner image and a black toner image.

Thus, on the drum 101, the magenta toner image is formed using the developing device 104M, the cyan toner image is formed using the developing device 104C, and the black toner image is formed using the developing device 104K. The respective color toner images formed as described above are successively transferred superposedly onto the intermediary transfer member 105, so that a synthetic toner image is formed.

The intermediary transfer member 105 contacts a transfer roller 106 at a secondary transfer portion T2. The intermediary transfer member 105 transfers the synthetic toner image onto a sheet P sent to the secondary transfer portion T2 by a feeding mechanism (not shown). Here, the sheet P is a recording material (sheet) on which an image is to be formed on a surface thereof.

After passing through the secondary transfer portion T2, the toner remaining on the intermediary transfer member 105 is removed by a toner cleaner 108. Incidentally, the toner cleaner 108 is movable toward and away from the intermediary transfer member 105, and is constituted so that the toner cleaner 108 is in a contact state with the intermediary transfer member 105 only when the intermediary transfer member 105 is cleaned.

Similarly, also the transfer roller 106 is movable toward and away from the intermediary transfer member 105, and is constituted so that the transfer roller 106 is in a contact state with the intermediary transfer member 105 only at timing of execution of the secondary transfer.

The sheet P passed through the secondary transfer portion T2 is introduced into a fixing device (heating device) 200 as a fixing portion, and is subjected to a fixing process (image heating process). The sheet P subjected to the fixing process is fed in a leftward arrow direction of FIG. 1 and is discharged to an outside the image forming apparatus, so that a series of image forming operations is ended.

When the sheet P subjected to the fixing process is fed to a reversing path 120, the sheet P is sent again to the secondary transfer portion T2 in a state in which an image forming surface thereof is turned upside down. Thus, by forming an image also on an opposite surface (back surface) of the sheet P, the images can be formed on both surfaces of the sheet P.

### [Fixing Device]

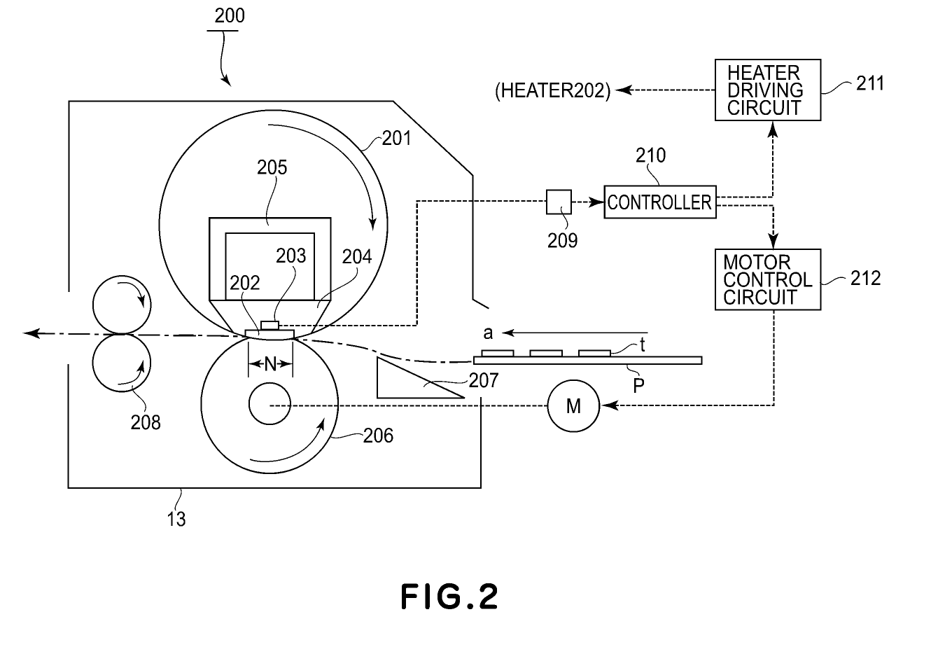

The fixing device 200 will be described with reference to FIG. 2 which is a schematic structural view thereof. The fixing device 200 is a fixing device (heating device) in which the sheet P on which an unfixed toner image t is formed is subjected to the fixing process in which the image is fixed on the sheet P by heating the sheet P. The fixing device 200 in this embodiment includes, as a pair of rotatable fixing members for nipping and feeding the sheet P, a fixing belt 201 and a pressing roller 206. The belt 201 and the roller 106 are in contact with each other at outer peripheral surfaces thereof, and between the belt 201 and the roller 206, a nip (fixing nip) N with a predetermined width with respect to a feeding direction a of the sheet P is formed.

In FIG. 2, the belt 201 rotates in the clockwise direction, and the roller 206 rotates in the counterclockwise direction. The sheet P fed from the secondary transfer portion T2 of the image forming portion 100A (FIG. 1) to the fixing device 200 is guided by a feeding guide 207 and reaches the nip N. The sheet P fed to the nip N is fed from a right-hand side to a left-hand side while being nipped between the belt 201 and the roller 206.

At this time, the belt 201 and the roller 206 function as a pair of rotatable feeding members, and this step is referred to as a nip-feeding step. In a process of this nip-feeding step, the toner image t on the sheet P contacts the belt 201, so that heat is imparted from the belt 201 to the toner image t. At this time, the belt 201 functions as one rotatable feeding member contacting the sheet P surface on which the toner image t is formed. The toner image t to which the heat is imparted is melted on the sheet P and is fixed on the sheet P. Thereafter, the sheet P is fed to an outside of the fixing device 200 by a discharging roller pair 208. A series of the above-described processes is referred to as the fixing process (image heating process).

Inside the belt 201, a fixing heater 202, a heater holder 204, a belt stay 205 and the like are provided.

The heater 202 is a heating source for heating the belt 201. Further, the heater 202 is an urging member for urging the belt 201 toward the roller 206. As the heater 202, for example, a ceramic heater is used. The ceramic heater is a low-thermal-capacity heater which abruptly generates heat by energization. The ceramic heater includes an alumina substrate, a heat generating resistor which generates heat by energization, and a heat-resistant gloss excellent in insulating property. The heat generating resistor is formed by screen-printing an electroconductive paste containing silver-palladium alloy on the alumina substrate. The heat generating resistor in this embodiment is applied onto the alumina substrate in a film of about 10 μm in thickness.

The heater 202 is disposed along a longitudinal direction (direction perpendicular to a recording material feeding direction and to a recording material thickness direction) of the belt 201. The heater 202 is disposed inside the belt 201 so as to be slidable with an inner surface of the belt 201. Incidentally, onto the inner surface of the belt 201, a semi-solid lubricant is applied, so that a sliding resistance between the heater 202 and the holder 204 is reduced.

The holder 204 is a member for holding the heater 202 along a longitudinal direction of the heater 202. The holder 204 fixes the heater 202 at a surface thereof on the roller 206 side. Further, the holder 204 is a guiding member for guiding a curvature shape of the belt 201 with respect to a circumferential direction so that the sheet P is easily separated from the belt 201. The holder 204 may desirably be excellent in heat-resistant property, and for example, a liquid-crystal polymer resin material can be used as a material of the holder 204.

The stay 205 is a supporting member for supporting the holder 204 and the heater 202 along the longitudinal direction. The stay 205 is disposed on a side opposite from the roller 206 while interposing the holder 204, the heater 202 and the belt 201 therebetween. The stay 205 is pressed toward the roller 206 at longitudinal end portions thereof. A pressing force (pressure) exerted on one end portion of the stay 205 is 156.8 N (16 kgf), so that a total pressure is 313.6 N (32 kgf).

By employing such a constitution, the stay 205, the holder 204 and the heater 202 presses the belt 201 against the roller 206. The roller 206 against which the belt 201 is pressed includes a rubber layer having a shape following the heater 202 while being elastically deformed. Thus, the nip N is formed between the belt 201 and the roller 206.

The roller 206 is an elastic roller having a multi-layer structure including a core metal, an elastic layer formed on the core metal, and a parting layer formed on the elastic layer. As the core metal, metal such as SUS can be used. As the elastic layer, for example, an about 3 mm-thick silicone rubber is usable as a material excellent in elasticity. As the parting layer, a fluorine-containing tube is usable as a material excellent in parting property. In this embodiment, an about 40 μm-thick PFA resin tube is used. Incidentally, PFA is a tetrafluoroethylene-perfluoro(alkylvinyl ether) copolymer.

The roller 206 is disposed so that its rotational axis direction (longitudinal direction) is substantially parallel to the longitudinal direction of the belt 201. As regards the roller 206 longitudinal end portions of the core metal are rotatably held through bearings between unshown side plates of a (fixing device) frame 13 on a front side and a rear side of the fixing device 200.

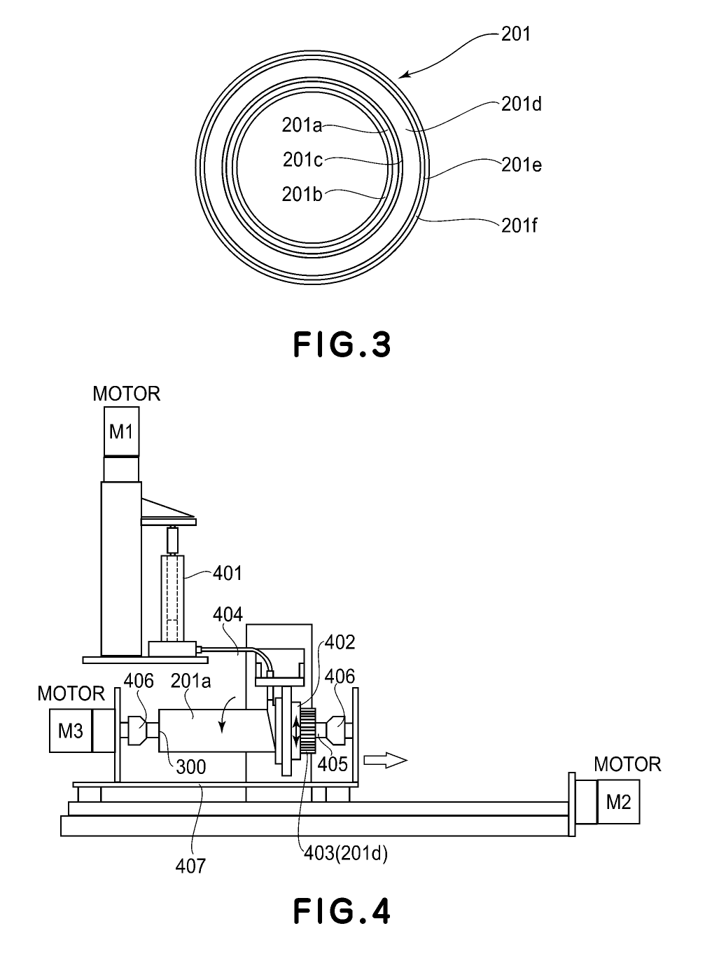

The core metal of the roller 206 is connected with a driving mechanism (not shown) including a motor M which is a driving source, and the roller 206 is rotationally driven in an arrow direction (counterclockwise direction) of FIG. 3 at a predetermined peripheral speed. The belt 201 in a press-contact state in the nip N with the rotationally driven roller 206 is rotated (clockwisely) by the roller 206 through transmission of the drive from the roller 206 by a frictional force in the nip N.

A thermistor 203 is a temperature sensor for detecting a temperature of the heater 202. The thermistor 203 is disposed so as to contact a back surface (opposite from the heating surface) of the heater 202. The thermistor 203 is connected with a control circuit portion (CPU) 210 through an A/D converter 209. The thermistor 203 outputs to the control circuit 210, a signal depending on the heater 202.

The control circuit 210 is a controller for controlling various constituent members of the printer 100. The control circuit 210 includes a calculating portion such as the CPU and a storing portion such as a memory. In the memory, respective programs are stored, and various kinds of control are carried out by reading the programs and then by effecting processing at the calculating portion.

The control circuit 210 performs sampling of an output from the thermistor 203 in a predetermined cycling period. Then, the control circuit 210 reflects temperature information acquired from the thermistor 203 in image control of the heater 202. Specifically, the control circuit 210 is electrically connected with a heater driving circuit portion 211 provides an energization instruction to the heater driving circuit portion 211 so that the temperature of the heater 202 is a target temperature (set temperature). That is, the control circuit 210 supplies electric power to the heater 202 on the basis of the output of the thermistor 203.

Further, the control circuit 210 is electrically connected with a motor control circuit portion 212 and provides an energization instruction to the motor control circuit portion 212 so that the driving motor M properly rotates.

### [Structure of Belt]

A structure of the belt 201 will be specifically described with reference to FIG. 3 which is a schematic cross-sectional view showing a belt layer structure. The belt 201 in this embodiment includes a fixing belt base member 201a which is formed in a cylindrical shape (endless shape, endless belt shape) and which has flexibility. The belt 201 includes a sliding layer 201b inside (on an inner peripheral surface) of the base member 201a. Further, outside (on an outer peripheral surface) of the base member 201a, a lamination layer including a primer layer 201c, an elastic layer 201d, an adhesive layer 201e and a surface layer 201f successively formed from an inside to an outside is provided.

### 1) Base Member

The base member 201a constitutes a base layer functioning as a base member (fundamental member) of belt 201. The base member 201a is required to have a heat-resistant property, and therefore, metal excellent in heat-resistant and flexing-resistant properties is used as a material of the base member 201a. A thickness of the base member 201a may preferably be not less than 10 μm and not more than 50 μm. In this embodiment, as the base member 201a, an endless member which has a thickness of 30 an inner diameter of 30 mm and a length of 400 mm and which is made of SUS (stainless steel) (hereinafter, this member is also referred to as an SUS base member) was used. A manufacturing method of the SUS base member will be specifically described later.

### 2) Sliding Layer

The sliding layer 201b is a layer for improving a sliding property between the belt 201 and the heater 202 and is formed on an inner peripheral surface of the base member 201a. Incidentally, in the case where there is no need to improve the sliding property between the belt 201 and the heater 202, the sliding layer may also be not provided.

As a material of the sliding layer 201b, a resin material having a high durability and a high heat-resistant property, such as polyimide resin, polyamideimide resin or polyether ether ketone resin is suitable. Particularly, from the viewpoints of ease of manufacturing, heat-resistant property, elastic modulus, strength and the like, the polyimide resin material may preferably be used.

In the case where the sliding layer 201b is formed of the polyimide resin material, the sliding layer 201b is formed in the following manner, for example. A polyimide precursor solution obtained by reaction of aromatic tetracarboxylic dianhydride or its derivative with aromatic diamine in the substantially same molar ratio in an organic polar solvent is applied (coated) onto an inner surface of the above-described base member 201a, followed by drying, heating and dewatering cyclization reaction. As a result, it is possible to form the sliding layer 201b with the polyimide resin material on the inner surface of the base member 201a.

In this embodiment, as the polyimide precursor solution, a solution of a polyimide precursor comprising 3,3′,4,4′-biphenyltetracarboxylic dianhydride and para-phenylene diamine in N-methyl-2-pyrrolidone was prepared. In a coating step, as a coating type, for example, a ring coating type can be used. After the coating, a drying step is performed for drying the precursor solution coated on the inner surface of the base member 201a. In the drying step, the base member 201a after being subjected to the coating step is left standing for 30 minutes in a hot air circulating reactor at 60° C., for example.

Thereafter, in order to form the polyimide precursor solution in polyimide resin by dewatering cyclization reaction, the base member 201a after the drying step is baked. In a baking step, the base member 201a is left standing for 10-60 minutes in the hot air circulating reactor in a temperature range (for example, 200-240° C.) in which fatigue strength of the base member 201a is not lowered. In this embodiment, the base member 201a after the drying step was baked for 20 minutes.

### 3) Elastic Layer

The elastic layer 201d is a silicone-rubber-made elastic layer coating an outer peripheral surface of the base member 201a through the printer layer 201c. The elastic layer 201d functions as a layer for providing the belt 201 with flexibility. By employing such a constitution, the belt 201 does not press the toner in the nip N more than necessary. Further, by employing such a constitution, the belt 201 can conduct heat to the toner in the nip N with reliability even when the sheet P is a sheet comprising uneven fibers.

The belt 201 is required to have ability to supply a sufficient heat quantity to the sheet P in a short time so that the toner can be melted in the nip N. Heat supplying ability of the belt 201 is represented by heat permeability (b=(λ×Cp×φ^{0.5} of the elastic layer as described in JP-A 2014-142611. That is thermal conductivity and volume thermal capacity of the elastic layer are designed so as to be high. As the elastic layer exhibiting the flexibility and the heat supplying ability as described above, as described in JP-A 2014-142611, a silicone rubber elastic layer prepared by mixing carbon fibers and an inorganic filler in an addition-curable silicone rubber as a base member and then by curing the mixture has been known.

At the addition-curable silicone rubber which is the base member, one containing an organopolysiloxane having an unsaturated aliphatic group, an organopolysiloxane having an active hydrogen bonded to silicon, and a platinum compound as a crosslinking catalyst can be used. The organopolysiloxane having the active hydrogen bonded to silicon forms a crosslinked structure by reaction thereof with an alkenyl group of the organopolysiloxane component having the unsaturated aliphatic group by means of catalysis of the platinum compound.

The carbon fibers and the inorganic filler are mixed while achieving a balance among the thermal conductivity, the thermal capacity, the flexibility and the like. In general, with an increasing amount of the inorganic filler mixed, although the thermal conductivity and the thermal capacity and improved, there is a tendency that the flexibility lowers. For this reason, a heat conduction path is formed among particles of the inorganic filler by the carbon fibers so as not to lose the flexibility. As a result, a ratio of an amount of the base member to a total amount of the carbon fibers and the inorganic filler can be increased, and therefore it is possible to achieve the balance of the thermal conductivity and the thermal capacity with the flexibility. As an example of the carbon fibers, it is possible to cite carbon fibers and a carbon nanotube.

As an example of the inorganic filler, it is possible to cite silicon carbide (SiC), silicon nitride (Si₃N₄), boron nitride (BN), aluminum nitride (AlN), alumina (Al₂O₃), zinc oxide (ZnO), magnesium oxide (MgO), silica (SiO₂), copper (Cu), aluminum (Al), silver (Ag), iron (Fe), nickel (Ni), and the like.

The inorganic filler can be used singly or in mixture of two or more species. An average particle size of the inorganic filler may preferably be 1 μm or more and 50 μm or less from the viewpoints of handling and dispersibility. Further, as a shape of the inorganic filler, a spherical shape, a pulverized shape, a plate shape, a whisker shape are used, but the spherical shape may preferably be used from the viewpoint of the dispersibility.

From the viewpoints of contribution to surface hardness of the fixing belt and efficiency of heat conduction to the unfixed toner during the fixing, a thickness of the elastic layer 201d may preferably be in a range of 100 μm or more and 500 μm or less, particularly in a range of 200 μm or more and 400 μm or less.

As a processing method of the elastic layer 201d, it is possible to cite processing methods, such as metallic molding, blade coating, nozzle coating and ring coating and the like. These processing methods have been described in JP-A 2001-62380, JP-A 2002-213432, and the like.

Next, a step of forming the silicone rubber elastic layer 201d on the base member 201a by the ring coating by using a coating device used in the ring coating shown in FIG. 4 will be described. In a cylinder pump 401, a coating liquid which is an addition-curable silicone rubber composition in which an addition-curable silicone rubber and a filler are mixed is charged. When pressure is exerted on a cylinder pump 401 by drive of a motor M1, the coating liquid is sent to a coating head 402 through a tube 404. Inside the coating head 402, a coating liquid supplying nozzle (not shown) is provided, and the coating liquid is coated on the outer peripheral surface of the base member 201a.

At this time, the base member 201 is integrally with cylindrical core metals 300 and 405 and is fed in a rightward direction of FIG. 4 at a certain speed by drive of a motor M2. Thus, the coating liquid can be coated in an entire area of the base member 201a. Incidentally, a motor M3 rotates a core metal holding tool 406 (and the base member 201a) as desired.

A thickness of the coating layer can be controlled by adjusting a clearance between the coating liquid supplying nozzle and the substrate 201a, a supplying speed of the silicone rubber composition, a moving speed of the base member 201a, and the like. In this embodiment, the clearance between the coating liquid supplying nozzle and the substrate 201a is 400 the supplying speed of the silicone rubber composition is 2.8 mm/s, and the moving speed of the substrate 201a is 30 mm/s. Further, a 300 μm-thick coating film (silicone rubber composition layer 403) is formed.

The addition-curable silicone rubber composition layer 403 coated on the base member 201a is heated by a heating device such as an electric furnace, so that cross-linking reaction is progressed and thus is changed to the silicone rubber elastic layer 201d. In this embodiment, the silicone rubber was coated and was baked at 200° C. for 30 min., so that the elastic layer 201d was formed. At this time, as the coated addition-curable silicone rubber, a silicone rubber mixture was used.

The silicone rubber mixture can be obtained in the following manner. First, high-purity spherical alumina particles as an inorganic filler is mixed in a commercially available addition-curable silicone rubber undiluted solution in a volume ratio of 25% on the basis of a cured silicone rubber layer. Thereafter, vapor deposition (vapor-phase growth) carbon fibers are added and kneaded in a volume ratio of 2.0%, so that the silicone rubber mixture was obtained.

As the commercially available addition-curable silicone rubber undiluted solution, an equivalent mixture of “A liquid” and “B liquid” (trade name: “SE 1886”, manufactured by Dow Corning Toray Co., Ltd.) was used. As the high-purity spherical alumina particles, alumina beads (trade name: “ALUMINABEADS CB-A25BC”, manufactured by Showa Denko Ceramics Co., Ltd.) was used. As the vapor deposition carbon fibers, carbon fibers (trade name: “VGCF-S”, manufactured by Showa Denko K.K.) was used.

Incidentally, in the case where an adhesiveness between the base member 201a and the elastic layer 201d is intended to be improved, the base member 201a may preferably be subjected to primer treatment in advance. In this embodiment, on the surface of the base member 201a, the primer layer 201c is formed. The primer layer 201c is required to have wettability with the base member 201a better than the silicone rubber elastic layer 201d. As such a primer, for example, it is possible to cite a hydrosilyl-based (SiH-based) silicone primer, a vinyl-based silicone primer, an alkoxy-based silicone primer.

Further, the primer layer 201c may desirably be formed in an amount to the extent that an adhesive performance is achieved and may desirably have less unevenness. A thickness of the primer layer 201c may desirably be about 0.5-5.0 μm. In this embodiment, in order to form the primer layer 201c, on an outer surface of the base member 201a, a hydrosilyl-based silicone primer (“DY39-051 A/B”, manufactured by Dow Corning Toray Co., Ltd.) was coated and was baked at 200° C. for 5 minutes.

### 4) Adhesive Layer

The adhesive layer 201e is a layer for fixing a resin tube 501 as the surface layer 501f on the cured silicone rubber elastic layer 201d. As the adhesive layer 201e, an addition-curable silicone rubber adhesive or the like can be used. The adhesive layer 201e may desirably be coated on the surface of the elastic layer 201d in a thickness of 1-10 μm. In this embodiment, on the outer surface of the elastic layer 201d, the silicone rubber adhesive was substantially uniformly coated in a thickness of about 10 μm.

Specifically, the addition-curable silicone rubber adhesive contains an organopolysiloxane having an unsaturated hydrocarbon group represented by a vinyl group, a hydrogen organopolysiloxane, and a platinum compound as a crosslinking catalyst. The addition-curable silicone rubber adhesive is cured by addition reaction. As such an adhesive, a known adhesive can be used.

In this embodiment, as the addition-curable silicone rubber adhesive, an adhesive (“Dow Corning (R) SE 1819 CV A/B”, manufactured by Dow Corning Toray Co., Ltd.) which is an equivalent mixture of “A liquid” and “B liquid” was used. Incidentally, an addition-curable silicone rubber adhesive in which a self-sheet component is mixed may also be used as the addition-curable silicone rubber adhesive.

### 5) Surface Layer

The surface layer 201f is a layer provided at an outermost surface of the belt 201 on an outer peripheral side. When unheated toner or toner in a heated or melted state is deposited on the surface of the belt 201, the toner causes image contamination. For that reason, the surface layer 201f may desirably be excellent in parting property with the toner.

As a material excellent in parting property, it is possible to cite a fluorine-containing resin material which is a thermoplastic resin. The fluorine-containing resin material includes a tetrafluoroethylene-perfluoro(alkylvinyl ether) copolymer (PFA), polytetrafluoroethylene (PTFE), tetrafluoroethylene-hexafluoropropylene copolymer (FEP), and the like. Particularly, from viewpoints of a molding property and a toner parting property, PFA may preferably be used.

In order to easily manufacture the belt 201, the surface layer 201f may desirably be a mold of the above-described fluorine-containing resin material in a tube shape (i.e., a fluorine-containing resin tube). In the following, the surface layer 201f is referred to as a resin tube or referred simply to as a tube. In this embodiment, the surface layer 201f was molded by extruding a melted PFA pellet from a cylindrical mold, so that a seamless tube with no seam with respect to a circumferential direction was prepared.

The molded tube-shaped surface layer 201f is bonded to the elastic layer 201d by the adhesive layer 201e. In the case where the inner surface of the surface layer 201f has been subjected to sodium treatment, excimer laser treatment, ammonia treatment or the like in advance, an adhesive property of the surface layer 201f with the elastic layer 201d is improved.

The surface layer 201f may desirably have a thickness of not more than 50 μm so that elasticity of the belt 201 can be maintained. Further, the surface layer 201f may desirably have a thickness of not less than 10 μm so that sufficient strength can be maintained. A dimension of the tube used as the surface layer 201f in this embodiment is 400 μm in length, 29 mm in inner diameter and 30 μm in thickness. Incidentally, the surface layer 201f may also be fluorine-containing resin coating.

### [Manufacturing Step of Belt Using Manufactured Base Member]

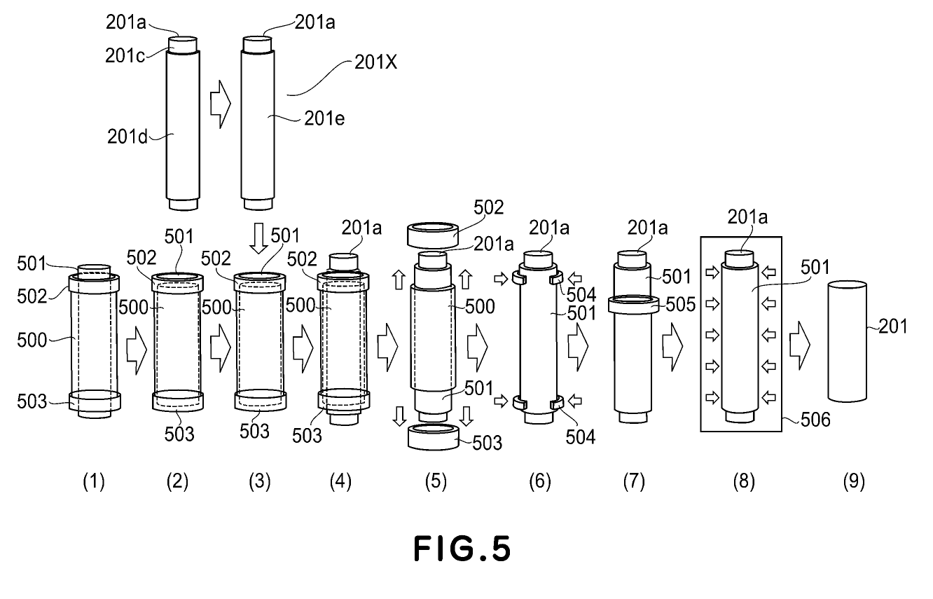

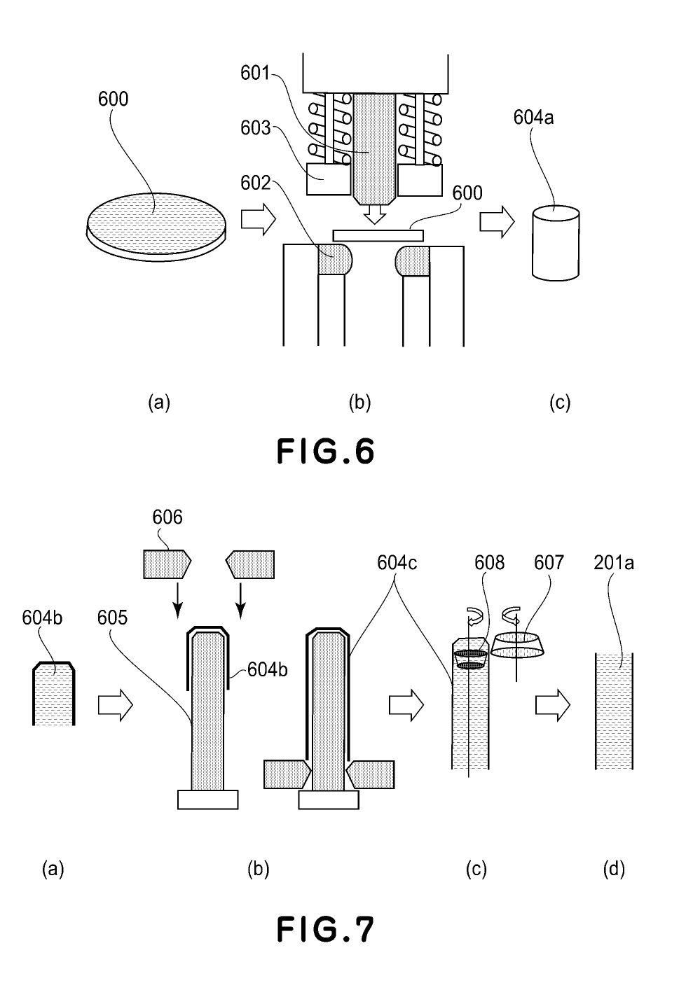

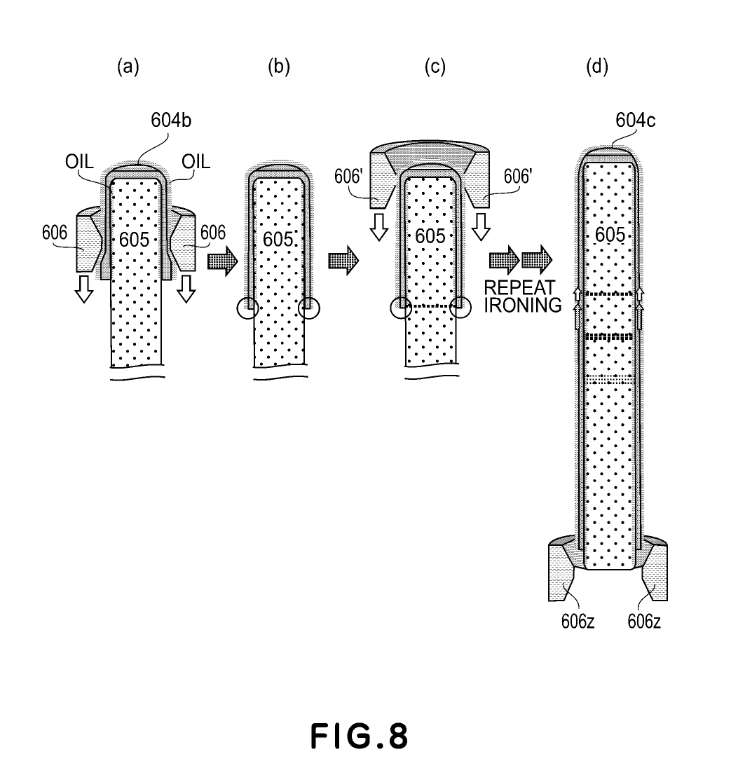

A manufacturing step of the base member 201a constituting the belt as the fixing member will be described later. Here, a manufacturing step (forming step) of the belt using the manufactured base member 201a will be described using FIG. 5.

In FIG. 5, steps starting from a step of preparing the tube 501 constituting the surface layer 201f and an inner layer 201X to be coated with the tube 501 until the belt 201 including the inner layer 201X coated with the tube 501 are shown in the order from a step (1) to a step (9). Here, the inner layer 201X is prepared by laminating the primer layer 201c and the elastic layer 201d in a named order on the base member 201a. The addition-curable silicone rubber adhesive is changed to the adhesive layer 201e by a heating process as described later.

As a coating method of the tube 501, a method in which the addition-curable silicone rubber adhesive is coated as a lubricant, a method in which the tube 501 is externally expanded and coated (expansion coating method), and the like method can be used. In this embodiment, the latter method is used, and in a manufacturing method of the belt 201, a step of inserting the inner layer 201X to an inside of the tube 501 in a state of being expanded in a radial direction is included.

In the step (1) shown in FIG. 5, inside a tube expansion die 500 made of metal, the tube 501 is disposed. At this time, the tube 501 is held at both end portions thereof by holding members 502 and 503.

Then, as shown in the step (2), the tube 501 is expanded (increased in diameter) in order to increase the diameter of the tube 501, a gap portion between an outer surface of the tube 501 and an inner surface of the tube expansion die 500 is placed in a vacuum state (negative pressure relative to ambient pressure). By placing the gap portion in the vacuum state (5 kPa in this embodiment), the outer surface of the tube 501 and the inner surface of the tube expansion die 500 are closely contacted to each other, so that the tube 501 is in the state of being increased in diameter.

Then, as shown in the step (3), into the expanded tube 501, the inner layer 201X is inserted. As shown at an upper portion of FIG. 5, onto the surface of the elastic layer 201d, the addition-curable silicone rubber adhesive constituting the adhesive layer 201e is uniformly applied (coated) in advance. Incidentally, the inner diameter of the tube expansion die 500 may be appropriately set when the insertion of the inner layer 201X into the tube 501 can be smoothly performed. That is, the inner diameter of the tube expansion die 500 is larger than an outer diameter of the inner layer 201X.

Then, as shown in the step (4), in a state in which the base member 201a is disposed inside the tube 501, the vacuum state of the gap portion between the outer surface of the tube 501 and the inner surface of the tube expansion die 500 is eliminated (i.e., the negative pressure relative to the ambient pressure is eliminated). When the vacuum state is eliminated, the inner diameter of the tube 501 is decreased (contracted) to the same diameter as the outer diameter of the base member 201a. That is, the inner surface of the tube 501 and the outer surface of the elastic layer 201d are in a closely contacted state through the addition-curable silicone rubber adhesive.

Then, as shown in the step (5), the tube 501 is elongated in a longitudinal direction thereof. In an elongation step, the holding members 502 and 503 are demounted from the end portions of the tube 501, and the tube 501 is elongated to a predetermined elongation ratio in the longitudinal direction. When the tube 501 is elongated, the addition-curable silicone rubber adhesive between the tube 501 and the elastic layer 201d functions as a lubricant. For that reason, the tube 501 can be smoothly elongated.

Thus, when the tube 501 is elongated in the longitudinal direction, creases do not readily generate on the tube 501, and therefore, the belt excellent in durability can be manufactured. In this embodiment, the tube 501 is elongated by 8% on the basis of a full length of the tube 501 in the longitudinal direction in the above-described step (4).

Then, as shown in the step (6), the tube 501 is temporarily fixed in the elongated state. As described above, the tube 501 is elongated in the longitudinal direction by 8% and therefore, a force for returning the length of the tube 501 to the original length acts on the tube 501. Therefore, in order to maintain the elongated state of the tube 501, the tube 501 is temporarily fixed when the tube expansion die 500 is demounted. In the temporary fixing step, the longitudinal end portions of the tube 501 in the elongated state are heated by a high-temperature metal block 504. The metal block 504 in this embodiment incorporates a heater, and a temperature of the metal block 504 is maintained at 200° C. in the predetermined time (20 seconds in this embodiment) in which the tube 501 is heated.

Then, as shown in the step (7), a step of squeezing an excessive addition-curable silicone rubber adhesive is performed. In the squeezing step, a squeezing process in which an entirety of the tube 501 is squeezed using a squeezing member 505 for uniformly pressing (urging) a full circumference of the tube 501 is carried out. By carrying out such a process, the silicone rubber adhesive (adhesive layer 201e) between the elastic layer 201d and the tube 501 is pushed out toward a longitudinal end portion of the belt 201.

Then, as shown in the step (8), the inner layer 201X coated with the tube 501 is subjected to a heating process. In a step of the heating process, the inner layer 201X coated with the tube 501 is left standing for a predetermined time in an electric furnace 506. In this embodiment, the adhesive was cured by being heated for 5 minutes in the electric furnace 506 set at 200° C. By this heating process, the addition-curable silicone rubber adhesive is cured and is charged to the adhesive layer 201e. Thus, a lamination state in which the tube 501 is laminated on the inner layer 201X is formed. That is, on the inner layer 201X, the surface layer 201f is formed.

Then, as shown in the step (9), the belt 201 is completed. In the completion step, longitudinal end portions of the inner layer 201X and the surface layer 201f are cut in a desired length so that the processing temporarily fixed in the above-described step (6) is removed.

### (Manufacturing Step of Base Member 201a Constituting Belt as Fixing Member]

In the following, a manufacturing method, using plastic working, of the base member 201a which constitutes the belt as the fixing member and which is made of stainless steel (SUS) in this embodiment will be described by dividing the manufacturing method into processes for obtaining a metal pipe in a first stage to a metal pipe in a third stage. Here, the plastic working refers to processing such that a material is deformed by a mechanical force and is shaped in a predetermined shape and a predetermined dimension by a property (plasticity) that deformation remains on the material even after the force is removed.

Further, drawing (processing) of the plastic working refers to processing such that a metal plate is formed and shaped by a pressing machine. Particularly, deep drawing refers to processing such that as in the case where a bottomed cylindrical container having a cup shape is formed from a circular plate, a flat plate-like material cut in a predetermined container is molded using a pair of female and male metal molds which are called a die and a punch.

Incidentally, in the following, a bottomed cylindrical member is referred to as a “cup-shaped cylindrical member” in some cases, but a “cup-shaped” does not refer to a shape with a handle, such as a coffee cup, but refers to a shape such as a cap with no handle or a tumbler. That is, the cup-shaped cylindrical member refers to a member having a shape such that one side of a cylinder is a bottom and the other side of the cylinder is an opening.

Incidentally, the bottom is not always positioned on a lower side relative to an opening end side with respect to a direction of gravitation. A surface (plane) positioned opposite from the opening end side, inclusive of the case where the bottom is positioned on an upper side relative to the opening end side with respect to the direction of gravitation.

Further, a circular shape of the bottom and a side surface is not limited to a perfect circle but may also be a shape slightly deviated from the perfect circle within a flexure or a tolerance.

### (Metal Pipe in First Stage)

Parts (a) to (c) of FIG. 6 are schematic views for illustrating a manufacturing method of the metal pipe in the first stage by the deep drawing. In this step, the metal plate pipe (first cup-shaped cylindrical member 604a) in the first stage is obtained by subjecting a stainless steel plate to the drawing (processing). A flat metal plate (blank) 600 shown in part (a) of FIG. 6 is a circular stainless steel plate and has a thickness of about 200 μm-400 μm. The kind of the stainless steel plate as the flat metal plate 600 may preferably be SUS 304, SUS 304L or the like from a viewpoint of a deed drawing property. A drawing processing punch 601 and a drawing processing die 602 constitute a pair of metal molds made of metal of which surfaces are subjected to superhard plating.

In FIG. 6, as shown in part (b), the flat metal plate 600 is sandwiched between the drawing processing punch 601 and the drawing processing die 602 and the drawing processing punch 601 is pushed in a downward arrow direction toward the drawing processing die 602. Simultaneously, the flat metal plate 600 is sandwiched between a crease-suppressing presser 603 and the drawing processing die 602, and is subjected to the drawing (processing) while suppressing generation of creases.

Further between the flat metal plate 600 and the drawing processing punch 601 and between the flat metal plate 600 and the drawing processing die 602, a high-viscosity lubricating oil or a solid lubricant such as graphite or molybdenum disulfide is interposed, so that a drawing property is improved. The above-described step (part (b) of FIG. 6) is performed about two to six times in general by subjecting the flat metal plate 600 to the deep drawing with different metal molds so that an outer diameter of the first cup-shaped cylindrical member 604a is gradually decreased. Thus, as shown in part (c) of FIG. 6, the first cup-shaped cylindrical member 604a is manufactured.

Incidentally, a method of obtaining (manufacturing) the first cup-shaped cylindrical member 604a is not limited to the above-described method in this embodiment, but impact processing (first step impact deep drawing) for shaping the flat metal plate by one-shot pressing may also be used.

A thickness of the first cup-shaped cylindrical member 604a at an open end may preferably be not less than 0.1 mm and less than 0.5 mm. This is because rigidity becomes lost when the thickness is less than 0.1 mm and becomes excessively large when the thickness is not less than 0.5 mm.

### (Metal Pipe in Second Stage)

Next, in order to alleviate (relax) residual stress of the first cup-shaped cylindrical member 604a, the first cup-shaped cylindrical member 604a is subjected to annealing (treatment). By subjecting the first cup-shaped cylindrical member 604a to the annealing at about 800° C.-1100° C. for 5 minutes-15 minutes in an environment of nitrogen gas and hydrogen gas or of argon gas, a cup-shaped cylindrical member 604b (FIG. 7) in which the residual stress was alleviated can be obtained.

Incidentally, a method of alleviating the residual stress of the first cup-shaped cylindrical member 604a is not limited to the annealing as in this embodiment, but a method of removing the residual stress by subjecting the first cup-shaped cylindrical member 604a to vibration or a method in which the residual stress is removed by shot blasting may also be used.

A surface Vicker's hardness (average of five measured values as measured by a microhardness tester (“HMV-1”, manufactured by Shimadzu Corp., pressing force=HV0.3, pressing time=10 seconds) in accordance with a Vicker's hardness test method (JIS 2244)) may desirably be in a range of not less than 200 HV0.3/10 and not more than 280 HV0.3/10.

When the surface Vicker's hardness of the cup-shaped cylindrical member 604b exceeds 280 HV0.3/10, the cup-shaped cylindrical member 604b is liable to cause season crack. Further, when the surface Vicker's hardness of the cup-shaped cylindrical member 604b is below 200 HV0.3/10, bending (flexure) fatigue strength of the manufactured (formed) base member 201a is low, so that lifetime extension of the belt 201 cannot be achieved.

The base member 201a capable of achieving the lifetime extension of the belt 201 refers to a base member such that the number of times of bending as measured in the following manner using a MIT type folding endurance tester (“DA type”, manufactured by Toyo Seiki Seisaku-sho, Ltd.) was discriminated as exceeding 1×10⁷ times. That is, in a test condition of 500 gf in load, 90° in bending (folding) angle, 280 cpm in bending speed, 10±0.1 mm in test piece width, and 20 samples in number of samples, a base member discriminated that the number of times of bending exceeded 1×10⁷ times is regarded as the base member 201 capable of achieving the lifetime extension of the belt 201. When the number of times of bending exceeds 1×10⁷ times, the base member is discriminated as “o”, and the number of times of bending does not exceed 1×10⁷, the base member is discriminated as “x”.

As a result, a base member 201a having a fatigue (endurance) limit of not less than 0.6% as calculated by an −N curvilinear regression method according to “Standard Evaluation Method of Fatigue Reliability for Metallic Materials)” (The Society of Material Science, Japan) is used. The belt 201 using the base member 201a having the fatigue limit of not less than 0.6% was incorporated in a full-color copying machine OR ADVANCE C5051, manufactured by Canon Inc.). Then, when a durability test in which 500 K (×10³) sheets were fed (A4 short-edge feeding) under setting of 313.6 N (32 kgf) in pressure, 8 mm×230 mm in fixing nip, 200° C. in fixing temperature, and 246 mm/sec in process speed was conducted, a belt crack or the like did not occur.

### (Metal Pipe in Third Stage)

Next, as shown parts (a) to (d) of FIG. 7, the cup-shaped cylindrical member 604b is elongated and thinned by being subjected to the plastic working and thus a bottomed cylindrical member 604c as a second cup-shaped member is prepared, and then, a bottom (longitudinal one end portion) of the bottomed cylindrical member 604c is cut, so that the base member 201a is obtained. Parts (a) to (d) of FIG. 7 show a series of steps in the above-described third stage. Incidentally, all parts (a) to (d) of FIG. 7 schematically show a cross-sectional shape of associated members.

First, an end portion of an ironing processing punch 605 which is a holding member, for holding the cup-shaped cylindrical member 604b, having a cylindrical shape or a circular column shape is covered with the cup-shaped cylindrical member 604b shown in part (a) of FIG. 7. The cup-shaped cylindrical member 604b used in this step may preferably have a surface Vicker's hardness in a range of not less than 200 HV0.3/10 and not more than 280 HV0.3/10.

Next, as shown in part (b) of FIG. 7, an ironing processing die 606 which is a ring-shaped member is externally fitted with the cup-shaped cylindrical member 604b by being moved in an arrow direction (longitudinal direction of the processing punch 605), and then ironing (processing) is carried out by reducing a clearance between the ironing processing punch 605 and the ironing processing die 606. The cup-shaped cylindrical member 604b is drawn (subjected to the ironing) by moving the ironing processing die 606 in a direction from a bottom side of the cup-shaped cylindrical member 604b toward an opening end side of the cup-shaped cylindrical member 604b.

Between the cup-shaped cylindrical member 604b and the ironing processing punch 605 and between the cup-shaped cylindrical member 604b and the ironing processing die 606, a high-viscosity lubricating oil or a solid lubricant such as graphite or molybdenum disulfide is interposed, so that an ironing (processing) property is improved. Incidentally, surface unevenness is provided on the surface of the ironing processing punch 605 by subjecting the surface of the ironing processing punch 605 to blasting (processing) or laser beam processing, so that the lubricating oil may also be made easily held on the surface of the ironing processing punch 605.

In this embodiment, as shown in FIG. 8, a plurality of kinds of ironing processing dies 606 having inner diameters successively decreasing with a decreasing thickness of the cup-shaped cylindrical member 604b are successively externally fitted with and moved along the cup-shaped cylindrical member 604b made of the stainless steel. As a result, the thickness of the cup-shaped cylindrical member 604b was gradually decreased, so that the cup-shaped cylindrical member 604b was thinned so as to have a predetermined thickness. Consequently, the bottomed cylindrical member 604c was obtained.

Incidentally, the ironing method is not limited to the above-described method. For example, when a plastic working method is capable of providing a total ironing ratio (plate thickness reducing ratio) of not less than 75%, the plastic working method is applicable to the ironing of the cup-shaped cylindrical member 604b.

When the bottomed cylindrical member 604c having the predetermined thickness is obtained, the bottomed cylindrical member 604c is extracted out of (demolded from) the ironing processing punch 605. Incidentally, the bottomed cylindrical member 604c may be extracted out of the mold by moving the ironing processing punch 605 relative to the bottomed cylindrical member 604c or by moving the bottomed cylindrical member 604c relative to the ironing processing punch 605. The case where the bottomed cylindrical member 604c is extracted out of the ironing processing punch 605 includes these two cases.

Further, as shown in part (c) of FIG. 7, the bottom of the bottomed cylindrical member 604c is cut using an outer cutting tool (edge) 607 and an inner cutting tool (edge) 608, so that the base member 201a can be obtained. Here, the other end portion (on the opening end side) of the bottomed cylindrical member 604c with respect to the longitudinal direction can also be cut using the outer cutting tool 607 and the inner cutting tool 608.

As a result, a cylindrical base member 201a as shown in part (d) of FIG. 7 is formed.

### [Waviness of Base Member 201a During Pass Production]

In the case where a plurality of base members 201a are manufactured by repetitively using the same ironing processing punch 605 and the same ironing processing die 606 in the above-described manufacturing method, there is a liability that waviness occurs on the surface of the base members 201a with respect to the longitudinal direction with an increasing number of times of manufacturing. A mechanism of occurrence of the waviness on the longitudinal surface of the base member 201a will be described using parts (a) to (d) of FIG. 8.

Part (a) of FIG. 8 is a schematic view showing a state in which the end portion of the ironing processing punch 605 is covered with the cup-shaped cylindrical member 604b and in which the cup-shaped cylindrical member 604b is drawn (subjected to the ironing) and elongated by moving the ironing processing die 606 in an arrow direction (longitudinal direction of the ironing processing punch 605). Between the cup-shaped cylindrical member 604b and the ironing processing punch 605 and between the cup-shaped cylindrical member 604b and the ironing processing die 606, a high-viscosity lubricating oil is interposed.

Part (b) of FIG. 8 is a schematic view showing a state, subsequent to the state of part (a) of FIG. 8, after the ironing processing die 606 passes through the cup-shaped cylindrical member 604b. The cup-shaped cylindrical member 604b is subjected to the ironing by the ironing processing die 606 and thus is drawn and elongated, and therefore, is longer than that in the state of part (a) of FIG. 8. Further, a gap (clearance) between the cup-shaped cylindrical member 604b and the ironing processing punch 605 is narrower than that in the state of part (a) of FIG. 8. Further, a lower end (opening end) of the cup-shaped cylindrical member 604b is open, and therefore, the lubricating oil is liable to become lost and thus an oil film is removed, so that the lower end (opening end) of the cup-shaped cylindrical member 604b is liable to cling to the surface of the ironing processing punch 605.

Part 8c) of FIG. 8 is a schematic view showing a state, subsequent to the state of part (b) of FIG. 8, in which a second ironing processing die 606′ for a second time contacts the cup-shaped cylindrical member 604b. The cup-shaped cylindrical member 604b is thinned by the first ironing, and therefore, the second ironing processing die 606′ is smaller in diameter than the first ironing processing die 606. When the cup-shaped cylindrical member 604b is subjected to the ironing by the second ironing processing die 606′ in contact with the cup-shaped cylindrical member 604b in a state in which the lower end of the cup-shaped cylindrical member 604b clings to the ironing processing punch 605, a clinging portion of the cup-shaped cylindrical member 604b moves. Then, minute scars are formed on the surface of the ironing processing punch 605 by the clinging portion.

Further, a lower end portion of the cup-shaped cylindrical member 604b drawn and elongated by the second ironing processing die 606′ is liable to cling to the surface of the ironing processing punch 605 similarly as in the case of the first ironing processing die 606. Then, when the cup-shaped cylindrical member 604b is subjected to the ironing by a third ironing processing die 606″ (not shown) for a third time, minute scars are formed on the surface of the ironing processing punch 605 by the cup-shaped cylindrical member 604b. Similarly, correspondingly to the number of times of the ironing including fourth ironing and fifth ironing, minute scars are formed on the surface of the ironing processing punch 605 by the cup-shaped cylindrical member 604b. Especially, the scars at a position where the scars are formed when the cup-shaped cylindrical member 604b is subjected to the ironing by the second ironing processing die 606′ are deepest (broken line position of part (c) of FIG. 8).

There are two reasons for this.

A first reason is that a thickness of the cup-shaped cylindrical member 604b when the cup-shaped cylindrical member 604b is drawn and elongated by the first ironing processing die 606 is still sufficiently thick. For this reason, rigidity of the lower end portion of the cup-shaped cylindrical member 604b is high, so that when the lower end portion of the cup-shaped cylindrical member 604b is moved by the second ironing processing die 606′, the scars are liable to scarred (damaged) on the surface of the ironing processing punch 605.

A second reason is that the single ironing processing punch 605 is repetitively used for thinly elongating the plurality of cup-shaped cylindrical members 604b. Among positions where the scars formed on the surface of ironing processing punch 605 during an ironing process of the plurality of cup-shaped cylindrical members 604b, a position corresponding to the lower end of the cup-shaped cylindrical member 604b when the cup-shaped cylindrical member 604b is subjected to the ironing by the first ironing processing die 606 is liable to become small in non-uniformity.

At that time, an elongation amount of the cup-shaped cylindrical member 604b by the first ironing processing die 606 is small in non-uniformity among those of the plurality of cup-shaped cylindrical members 604b since the ironing is first ironing for the plurality of cup-shaped cylindrical members 604b. That is, the scars formed on the ironing processing punch 605 at the position corresponding to the lower end of the cup-shaped cylindrical member 604b subjected to the ironing by the first ironing processing die 606 are liable to coincide with each other when the ironing processing punch 605 is repetitively used for the plurality of the cup-shaped cylindrical members 604b.

On the other hand, an elongation amount when a certain cup-shaped cylindrical member 604b is subjected to the ironing plural times by the ironing processing dies includes non-uniformity (variation) of elongation amounts during preceding ironing processes (including those with the first and second ironing processing dies 606 and 606′). For that reason, during repetitive use of the ironing processing punch 605 for the plurality of cup-shaped cylindrical members 604b, the position where the lower end of the cup-shaped cylindrical member 604b clings to the ironing processing punch 605 is liable to deviate for each of the plurality of cup-shaped cylindrical members 604b.

Part (d) of FIG. 8 is a schematic view showing a state in which a final ironing processing die 606z passed through the cup-shaped cylindrical member 604b.

The ironing processing die draws and elongates the cup-shaped cylindrical member 604b in contact with the cup-shaped cylindrical member 604b, but is liable to be returned toward an original position correspondingly to a degree of elastic deformation when the ironing processing die passed through the cup-shaped cylindrical member 604b. This phenomenon is spring back.

When the cup-shaped cylindrical member 604b is liable to be returned toward the original position, a frictional force is changed depending on a surface shape of the ironing processing punch 605 contacting the inner surface of the cup-shaped cylindrical member 604b. If the scars and the like are not formed on the surface of the ironing processing punch 605 and surface roughness is uniform, the frictional force is unchanged, and therefore, a degree of the spring back of the cup-shaped cylindrical member 604b is uniform and thus the cup-shaped cylindrical member 604b contracts correspondingly to the degree of elastic deformation. However, when the surface of the ironing processing punch 605 are partially scarred and thus the surface roughness becomes non-uniform, the frictional force changes and the degree of the spring back of the cup-shaped cylindrical member 604b becomes non-uniform, so that waviness is caused to occur on the surface of the cup-shaped cylindrical member 604b.

The spring back occurs every time when the ironing processing die passed through the cup-shaped cylindrical member 604b, such as when the first ironing processing die 606 passed through the cup-shaped cylindrical member 604b or when the second ironing processing die 606′ passed through the cup-shaped cylindrical member 604b. Further, when the spring back occurs, the waviness is caused to occur on the surface of the cup-shaped cylindrical member 604b in some cases. The waviness occurring when the ironing processing dies other than the final ironing processing die passed through the cup-shaped cylindrical member 604b is elongated and flattened by the ironing with a subsequent ironing processing die.

However, there is a liability that the waviness occurring when the final ironing processing die 606z passed through the cup-shaped cylindrical member 604b remains without being flattened.

Here, in order to improve bending durability of the base member 201a, when the cup-shaped cylindrical member 604b having high hardness such that the Vicker's hardness of not less than 200 HV0.3/10 is used, the minute scars formed on the surface of the ironing processing punch 605 by the end portion of the cup-shaped cylindrical member 604b on the opening end side are liable to become deep. Further, as regards the stainless steel material, there is a tendency that tensile strength increases with an increasing hardness, and therefore, the degree of the spring back also increases. By these factors, there is a liability that the influence of the scars on the surface of the ironing processing punch 605 appears as the waviness on the surface of the cup-shaped cylindrical member 604b in an early stage during pass production.

This waviness also remains on the base member 201, and even when on an outside of the metallic base layer, the elastic layer of the silicone rubber and the parting layer of the fluorine-containing resin tube are formed, the influence of the waviness changes pressure in the nip during the fixing. As a result, there is a liability that an image defect such as uneven glossiness is caused to occur.

### [Relationship Between Surface Hardness of Cup-Shaped Cylindrical Member 604 Band Surface Hardness of Ironing Processing Punch 605]

The present inventors have found that in order to manufacture the base member 201a excellent in bending durability with high pass productivity, a relationship between surface amount of the cup-shaped cylindrical member 604b and surface hardness of the ironing processing punch 605 is important.

As described above, in order to manufacture the base member 201a excellent in bending durability, the surface Vicker's hardness of the cup-shaped cylindrical member 604b used in the ironing process may preferably be not less than 200 HV0.3/10 and not more than 280 HV0.3/10.

Further, in order to manufacture the base member 201a excellent in bending durability with high pass productivity, the surface Vicker's hardness of the ironing processing punch 605 which is the holding member for holding the cup-shaped cylindrical member 604b is made not less than 4.0 times and not more than 9.0 times the surface Vicker's hardness of the cup-shaped cylindrical member 604b.

From a result of the following embodiments, in order to manufacture the base member 201a excellent in bending durability with high pass productivity, the surface Vicker's hardness of the ironing processing punch 605 may preferably be made not less than 4.0 times the surface Vicker's hardness of the cup-shaped cylindrical member 604b. Incidentally, although the pass productivity is improved with larger value of the surface Vicker's hardness when the surface Vicker's hardness of the ironing processing punch 605 is not less than 4.0 times the surface Vicker's hardness of the cup-shaped cylindrical member 604b, from a viewpoint of a punch manufacturing cost, the surface Vicker's hardness of the ironing processing punch 605 may preferably be made not more than 9.0 times the surface Vicker's hardness of the cup-shaped cylindrical member 604b. A general-purpose ironing processing punch which is made of cemented carbide (hard metal) and which has high hardness is about 1800 HV in surface Vicker's hardness. Cemented carbide harder than the (general-purpose) cemented carbide also exists, but is used for a special purpose, and therefore, there is a liability that a punch manufacturing cost becomes high. That is, the surface Vicker's hardness of the ironing processing punch 605 is made not less than 4.0 times and not more than 9.0 times the surface Vicker's hardness of the cup-shaped cylindrical member 604b, preferably made not less than 4.0 times and not more than 5.2 times the surface Vicker's hardness of the cup-shaped cylindrical member 604b as described in the following embodiments.

In the following, using Embodiments 1 to 3, description will be made specifically.

### Embodiment 1

In this embodiment, an ironing processing punch 605 (FIG. 7) as the holding member was manufactured using cemented carbide (“FUJILLOY”, manufactured by FUJI DIE Co., Ltd.). The surface Vicker's hardness of the ironing processing punch 605 in this embodiment was 1198 HV0.3/10. Further, as a comparison example, an ironing processing punch 605 was manufactured using alloy tool steel (SKD). The surface Vicker's hardness of the ironing processing punch 605 in the comparison example was 697 HV0.3/10.

Using the ironing processing punches 605 in this embodiment and in the comparison example, base members 201a were manufactured from cup-shaped cylindrical members 604b having the surface Vicker's hardness of 240±10 HV0.3/10 (FIG. 7). Values of a surface amount Wt (maximum cross-sectional height of a waviness curve) with respect to a longitudinal direction of a 1000-th base member 201a, a 3000-th base member 201a, a 5000-th base member 201a and a 7000-th base member 201a were measured using a measuring device (“SURFCORDER SE600”, manufactured by Kosaka Laboratory Ltd.).

Specifically, measurement was made under a condition of: cutoff=fh 0.25 mm-fl 8 mm, filter characteristic=Gaussian, reserve length=cutoff×0.5, leveling=linear (entire area), evaluation length=16 mm, drive (feeding) speed=2 mm/s, stylus=tip radius R: 2 mm, tip angle: 60 degrees, made from diamond.

Further, uneven glossiness checked in the following manner. Belts 201 are prepared using the 1000-th base member 201a, the 3000-th base member 201a, the 5000-th base member 201a and the 7000-th base member 201a. Then, each of the belts 201 was incorporated in the full-color copying machine OR ADVANCE C5051, manufactured by Canon Inc.), and setting of 313.6 N (32 kgf) in pressure, 8 mm×230 mm in fixing nip, 200° C. in fixing temperature, and 246 mm/sec in process speed was set. Then, blue solid images were outputted on papers (sheets) (“OK Top Coat”, manufactured by Oji Paper Co., Ltd., paper glossiness: 45°, basis weight: 128 g/m²), and then the uneven glossiness was checked.

The uneven glossiness was discriminated as “x” when the uneven glossiness was clearly recognized, “A” when the uneven glossiness was slightly recognized, and “o” when the uneven glossiness was not recognized. Results of the waviness Wt and the uneven glossiness of the blue solid image are shown in Table 1.

TABLE 1

| Punch 605 | BM⁺¹ | Wt*² (μm) | UG*³ |
|---|---|---|---|
| EMB. 1 | 1000-th | 2.8 | ∘ |
| ″ | 3000-th | 2.9 | ∘ |
| ″ | 5000-th | 2.9 | ∘ |
| ″ | 7000-th | 3.1 | ∘ |
| COMP. Ex. | 1000-th | 3.0 | ∘ |
| ″ | 3000-th | 3.6 | Δ |
| ″ | 5000-th | 4.2 | x |
| ″ | 7000-th | 4.7 | x |

*¹“BM” represents the base member 201a.
*²“Wt” represents the waviness Wt of the base member 201a.
*³“UG” represents the uneven glossiness of the blue solid image.

From the results of Table 1, even when 7000 belts 201 were manufactured, large waviness does not generate on the surface of the base members 201a in the case of using the ironing processing punch 605 in this embodiment, and the belts 201 manufactured using the base members 201a do not generate the uneven glossiness of the solid image leading to the image defect. On the other hand, the 3000-th base member 201a manufactured using the ironing processing punch 605 in the comparison example and the associated belt 201 in the comparison example generated the slight uneven glossiness of the solid image. Further, the 5000-th base member 201a manufactured using the ironing processing punch 605 in the comparison example and the associated belt 201 in the comparison example generated the uneven glossiness regarded as an improper image quality.

This would be considered because a difference in uneven glossiness between this embodiment and the comparison example is generated by a difference in surface Vicker's hardness between the ironing processing punch 605 in this embodiment and the ironing processing punch 605 in the comparison example. The surface Vicker's hardness of the ironing processing punch 605 in the comparison example used for processing the cup-shaped cylindrical member 604b having the surface Vicker's hardness of 240±10 HV0.3/10 is 697 HV0.3/10. That is, the surface Vicker's hardness of the ironing processing punch 605 in the comparison example is merely 2.8 times to 3.0 times the surface Vicker's hardness of the cup-shaped cylindrical member 604b.

On the other hand, the surface Vicker's hardness of the ironing processing punch 605 in this embodiment is 1198 HV0.3/10. For this reason, the surface Vicker's hardness of the ironing processing punch 605 in this embodiment is not less than 4.8 times and not more than 5.2 times the surface Vicker's hardness of the cup-shaped cylindrical member 604b. When a difference in surface hardness between the cup-shaped cylindrical member 604b and the ironing processing punch 605 is large, the scars are not readily formed even in the case where the lower end of the cup-shaped cylindrical member 604b clings to the ironing processing punch 605 when the cup-shaped cylindrical member 604b is drawn and elongated.

The surface of the ironing processing punch 605 in this embodiment is not readily scarred, so that the waviness of the cup-shaped cylindrical member 604b having the influence on the fixing performance is suppressed, and thus the base member 201a can be manufactured with high pass productivity.

### Embodiment 2

In this embodiment, an ironing processing punch 605 was manufactured using alloy tool steel (SKD) and then the surface of the ironing processing punch 605 was subjected to hard chromium plating. The surface Vicker's hardness of the ironing processing punch 605 in this embodiment was 1085 HV0.3/10.

Results of evaluations which are the same as those in Embodiment 1 and which are made using the ironing processing punch 605 in this embodiment are shown in Table 2.

TABLE 2

| Punch 605 | BM⁺¹ | Wt*² (μm) | UG*³ |
|---|---|---|---|
| EMB. 2 | 1000-th | 2.9 | ∘ |
| ″ | 3000-th | 3.1 | ∘ |
| ″ | 5000-th | 3.2 | ∘ |
| ″ | 7000-th | 3.4 | ∘ |

*¹“BM” represents the base member 201a.
*²“Wt” represents the waviness Wt of the base member 201a.
*³“UG” represents the uneven glossiness of the blue solid image.

From the results of Table 2, even when 7000 belts 201 were manufactured, large waviness does not generate on the surface of the base members 201a in the case of using the ironing processing punch 605 in this embodiment, and the belts 201 manufactured using the base members 201a do not generate the uneven glossiness of the solid image leading to the image defect.

The surface Vicker's hardness of the ironing processing punch 605 in this embodiment is 1085 HV0.3/10. For this reason, the surface Vicker's hardness of the ironing processing punch 605 in this embodiment is not less than 4.3 times and not more than 4.7 times the surface Vicker's hardness of the cup-shaped cylindrical member 604b.

As a result, similarly as in Embodiment 1, the surface of the ironing processing punch 605 in this embodiment is not readily scarred, so that the waviness of the cup-shaped cylindrical member 604b having the influence on the fixing performance is suppressed, and thus the base member 201a can be manufactured with high pass productivity.

### Embodiment 3

In this embodiment, an ironing processing punch 605 similar to that in Embodiment 2 (in which the ironing processing punch 605 was manufactured using alloy tool steel (SKD) and then the surface of the ironing processing punch 605 was subjected to hard chromium plating) and a cup-shaped cylindrical member 604b having the surface Vicker's hardness of 260±10 HV0.3/10 were used.

Results of evaluations which are the same as those in Embodiment 1 are shown in Table 3.

TABLE 3

| Punch 605 | BM⁺¹ | Wt*² (μm) | UG*³ |
|---|---|---|---|
| EMB. 3 | 1000-th | 2.9 | ∘ |
| ″ | 3000-th | 3.2 | ∘ |
| ″ | 5000-th | 3.4 | ∘ |
| ″ | 7000-th | 3.7 | Δ |

*¹“BM” represents the base member 201a.
*²“Wt” represents the waviness Wt of the base member 201a.
*³“UG” represents the uneven glossiness of the blue solid image.

From the results of Table 3, the belt 201 manufactured from the 7000-th base member 201a with the ironing processing punch 605 in this embodiment generated slight uneven glossiness of the solid image, but was at a level having no problem in practical use. The belts 201 manufactured from the 1000-th base member 201a, the 3000-th base member 201a and the 5000-th base member 201a with the ironing processing punch 605 in this embodiment do not generated uneven glossiness of the solid image leading to the image defect.

The surface Vicker's hardness of the cup-shaped cylindrical member 604b is 260±10 HV0.3/10, and the surface Vicker's hardness of the ironing processing punch 605 in this embodiment is 1085 HV0.3/10. For this reason, the surface Vicker's hardness of the ironing processing punch 605 in this embodiment is not less than 4.0 times and not more than 4.3 times the surface Vicker's hardness of the cup-shaped cylindrical member 604b.

As a result, similarly as in Embodiments 1 and 2, the surface of the ironing processing punch 605 in this embodiment is not readily scarred, so that the waviness of the cup-shaped cylindrical member 604b having the influence on the fixing performance is suppressed, and thus the base member 201a can be manufactured with high pass productivity.

Here, a manufacturing method for manufacturing the rotatable fixing member includes the above-described manufacturing step of manufacturing the base member of the rotatable fixing member, the forming step of forming the elastic layer on the outside of the base member, and the forming step of forming the surface layer on the outside of the elastic layer.

In the above-described embodiments, preferred embodiments of the present invention were described, but the present invention is also applicable to embodiments described below.

In the above-described embodiments, in the first step, the cup-shaped cylindrical member 604a as the first cup-shaped member by subjecting the stainless steel plate to the drawing (processing). Then, in the second step, the cup-shaped cylindrical member 604b (prepared by subjecting the cup-shaped cylindrical member 604a to the annealing (processing) held at an inside thereof by the ironing processing punch 605 is subjected to the ironing (processing) by the ironing processing punch 605 moving in the longitudinal direction of the ironing processing punch 605 at an outside of the cup-shaped cylindrical member 604a. As a result, the cup-shaped cylindrical member 604c as the second cup-shaped member which is elongated and thinned from the cup-shaped cylindrical member 604b is formed.

Then, in the third step, the cup-shaped cylindrical member 604c as the third cup-shaped member is extracted out of the ironing processing punch 605. Then, in the fourth step, the longitudinal end portion of the cup-shaped cylindrical member 604c as the second cup-shaped member is cut.

However, the present invention is not limited to above-described steps. For example, in the case where the residual stress of the cup-shaped cylindrical member 604a as the first cup-shaped member is small, the cup-shaped cylindrical member 604a can also be subjected to the second step as it is without alleviating the residual stress by being subjected to the annealing or the like. However, in order to form the base member 201a capable of extending the lifetime of the belt 201, the surface Vicker's hardness of the cup-shaped cylindrical member 604b used in the second step may preferably be a range of not less than 200 HV0.3/10 and not more than 280 HV0.3/10.

Further, the third step is not limited to a step performed before the fourth step, but may also be a step performed after the fourth step. That is, after the longitudinal end portion is cut, the cup-shaped cylindrical member 604c as the second cup-shaped member is extracted out of the ironing processing punch 605.

Further, in the fourth step, the cutting of the longitudinal end portion of the second cup-shaped member is not limited to cutting of one end portion corresponding to the cup-shaped bottom side but may also be cutting of both end portions inclusive of the end portion opposite from the one end portion corresponding to the cup-shaped bottom side.

In the above-described embodiments, as the heater 202 used as the heating member for heating the nip, the ceramic heater contacting the belt 201 was used, but the heater is not limited thereto. For example, it is also possible to use a halogen heater provided at a position where the halogen heater is spaced from the belt 201 and is inside the belt 201.

In the above-described embodiments, the fixing device for fixing the unfixed toner image on the recording material was described, but the present invention is not limited thereto. The present invention is also applicable to a device for heating and pressing a toner image temporarily fixed on the recording material in order to improve glossiness of an image (also in this case, the device is referred to as the fixing device).

In the above-described embodiments, the constitution in which the rotatable fixing member 201 includes the base member 201a, the elastic layer 201d and the surface layer 201f was described, but a rotatable fixing member including no elastic layer 201d may also be used. That is, in a manufacturing method of a rotatable fixing member in which the surface layer excellent in parting property is provided outside the base member, the base member may also be manufactured by the methods described in the above-described embodiments.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-193375 filed on Oct. 3, 2017, which is hereby incorporated by reference herein in its entirety.

What is claimed is:

1. A manufacturing method of a stainless-steel-made base member of a rotatable fixing member, said manufacturing method comprising:
a first step of forming, from a first cup-shaped member made of a stainless steel and held at an inside portion thereof by a holding member, a second cup-shaped member made thinner than the first cup-shaped member by ironing an outside portion of the first cup-shaped member with a ring-shaped member movable in a longitudinal direction of the holding member;
a second step of extracting the second cup-shaped member out of the holding member; and
a third step of cutting a bottom end portion of the second cup-shaped member with respect to the longitudinal direction,
wherein the first cup-shaped member has Vickers hardness of not less than 200 HV0.3/10 or more and not more than 280 HV0.3/10, and the holding member has Vickers hardness which is not less than four times and not more than nine times the Vickers hardness of the first cup-shaped member.

2. A manufacturing method according to claim 1, further comprising a drawing step of forming the first cup-shaped member by subjecting a stainless steel plate to drawing.

3. A manufacturing method according to claim 2, further comprising a step of alleviating a residual stress of the first cup-shaped member between said drawing step and said first step.

4. A manufacturing method according to claim 2, further comprising a step of annealing the first cup-shaped member between said drawing step and said first step.

5. A manufacturing method according to claim 2, wherein said drawing step is an impact processing step.

6. A manufacturing method according to claim 1, wherein in said first step, the first cup-shaped member is subjected to ironing with the ring-shaped member having a first inner diameter and thereafter is subjected to ironing with the ring-shaped member having a second inner diameter.

7. A manufacturing method according to claim 1, in said first step, a lubricant is interposed between the first cup-shaped member and the ring-shaped member.

8. A manufacturing method according to claim 1, wherein said second step is performed before said third step.

9. A manufacturing method according to claim 1, wherein in said third step, both end portions of the second cup-shaped member with respect to the longitudinal direction are cut.

10. A manufacturing method according to claim 1, wherein a shape of the holding member is a cylindrical shape or a circular column shape.

11. A manufacturing method according to claim 1, wherein the base member of the rotatable fixing member has a thickness of not less than 10 μm and not more than 50 μm.

12. A manufacturing method according to claim 1, wherein the first cup-shaped member has a thickness of not less than 0.1 mm and less than 0.5 mm.

13. A manufacturing method of a rotatable fixing member comprising:
(i) a manufacturing step of manufacturing a base member made of stainless steel;
(ii) a forming step of forming a surface layer outside the base member manufactured by said manufacturing step,
wherein said manufacturing step comprises,
(ii-i) a first step of forming, from a first cup-shaped member made of a stainless steel and held at an inside portion thereof by a holding member, a second cup-shaped member made thinner than the first cup-shaped member by ironing an outside portion of the first cup-shaped member with a ring-shaped member movable in a longitudinal direction of the holding member,
(ii-ii) a second step of extracting the second cup-shaped member out of the holding member, and
(ii-iii) a third step of cutting a bottom end portion of the second cup-shaped member with respect to the longitudinal direction,
wherein the first cup-shaped member has Vickers hardness of not less than 200 HV0.3/10 or more and not more than 280 HV0.3/10, and the holding member has Vickers hardness which is not less than four times and not more than nine times the Vickers hardness of the first cup-shaped member.

14. A manufacturing method according to claim 13, further comprising a step of forming an elastic layer between the base member and the surface layer.
